(19) United States
(12) Patent Application Publication
(10) Pub. No.: US 2022/0215348 A1
(43) Pub. Date: Jul. 7, 2022

(54) ATTENDANCE MANAGEMENT METHOD, ATTENDANCE MANAGEMENT PROGRAM, AND ATTENDANCE MANAGEMENT SYSTEM

(71) Applicant: Takao TANNO, Tokyo (JP)

(72) Inventor: Takao TANNO, Tokyo (JP)

(21) Appl. No.: 17/703,622

(22) Filed: Mar. 24, 2022

Related U.S. Application Data
(63) Continuation of application No. PCT/JP2020/034522, filed on Sep. 11, 2020.

(30) Foreign Application Priority Data
Sep. 25, 2019 (JP) 2019-174703
Aug. 7, 2020 (JP) 2020-134384

(51) Int. Cl. G06Q 10/10

(52) U.S. Cl. CPC G06Q 10/1091

(57) ABSTRACT

An attendance management method according to the present invention comprises: a step in which, at each of a plurality of times a worker starts work during one day, when a computer is operated so as to record the start time or when the computer detects the start of work by the worker, the computer generates a data record for recording the start time and records the start time in the data record generated; and a step in which, when the computer is operated by the worker to record an end time or detects the end of work by the worker, the computer records the end time in the data record in which the most recent start time is registered.

### INCORPORATION BY REFERENCE

This application is a continuation of PCT Application No. PCT/JP2020/034522, filed on Sep. 11, 2020, which is based upon and claims the benefit of priority from Japanese Patent Application No. 2019-174703 filed on Sep. 25, 2019 and Japanese Patent Application No. 2020-134384 filed on Aug. 7, 2020, the disclosure of those prior applications are incorporated herein by reference in their entirety.

### BACKGROUND

The present disclosure relates to an attendance management method, an attendance management program, and an attendance management system for grasping and managing work hours of workers.

Attendance management systems generally include management of work hours for workers, normal work hours, overtime hours, and normal hours/overtime hours per a job that is responsible for workers. Conventionally, various systems and methods have been known as techniques for configuring such an attendance management system.

In Patent Literature 1 (Japanese Patent No. 6430052), for example, attendance/leaving time of a worker's self-report and attendance/leaving time stamped by a card reader or the like will be described. Alternatively, a technique has been disclosed in which a working time is calculated on the basis of a time at which a worker logs on an information terminal to be used for business, and a log off operation is performed, thereby obtaining working time and improving accuracy of worker time management.

Further, Patent Literature 2 (Japanese Unexamined Patent Application Publication No. 2013-240961) discloses an attendance management sheet that can improve the efficiency of management work. Employee identification information and each day of the week of the month for the employee are arranged in a list format on one form. Information necessary for labor management can be provided by providing a column in which multiple deficiencies that do not meet the prescribed number of working days and working hours within the month can be entered and a column in which the number of days and working hours corresponding to these deficiencies can be entered.

Further, Patent Literature 3 (Japanese Unexamined Patent Application Publication No. 2002-288402) discloses a technique for realizing a local arrival authentication and a work management method for a dispatch worker in a dispatch service suitable for use in, for example, visit care.

### SUMMARY

While the prior art described above discloses aspects of various attendance management systems, they all presuppose a working pattern of one work in one day.

That is, in Patent Literature 1, based on the following information, attendance time/leaving time is determined, and one working time on that day is calculated. One is the time of attendance/leaving by the worker's self-report. The other is the attendance/leaving time stamped by a card reader or the like.

Furthermore, the time when the worker logs on to the information terminal used for work (starting time stamping operation) and logs off (ending work time stamping operation). The attendance/leaving (exit) time for the working hours calculated in this way is one set.

In Patent Literature 2, a work time of one day is grasped and displayed in a list. Again, the work hours for one day is one, and the corresponding attending-and-leaving-the-office time for a day is also one set.

Patent Literature 3 discloses a technique for grasping an arrival at each visit or a start and end time at a visited site in a visit care service by a home helper or the like. In this document, for example, as seen in the 0024 paragraph, “carrying out attendance management of dispatch workers” refers to managing the start and end time of work at a visited site. However, the term “attendance management” is different from “attendance management” of the present invention, i.e., comprehension/management of the attendance/leaving time, and refers to managing the start time and the end time of the work at each visit destination while visiting several visit care destinations at several places in one day of work.

That is, in Patent Literature 3, a visiting care service using a home helper or the like is disclosed in the 0003 paragraph, and as an effect of the invention, a “progress management can be managed in real time” is described in the 0031 paragraph.

From these descriptions, it is clear that the home helper or the like is in a work pattern in which a visiting care destination is circulated several places during a time period from an attendance to a leaving on the day. The home helper or the like is an employee of a visiting care service provider, and as the employee, the time of attendance and leaving on the day is one set.

In addition, to see an embodiment in a general enterprise, an entrance and exit of an office or an entrance and exit of a business office, for example, a so-called flapper gate installation is installed, and when an employee holds an employee ID card or a dedicated security card on a card sensor part of this gate is provided, the time of entrance (attendance)/exit (leaving) is grasped.

Looking at the actual operation of such companies, for example, the entrance stamp when going to work in the morning, the exit stamp when going out of the venue during lunch break, the entrance stamp when re-entering before the end of lunch break, and the time when leaving work in the evening are grasped for each. Then, the earliest entry time is grasped as the attendance time, and the latest leaving time is regarded as the leaving time, and the attendance is managed by regarding it as one pair of attendance/leaving times.

In this case, the reason for recognizing the earliest entry time and the latest leaving time as one set of attendance/leaving time and managing as an attendance is that the exit of the lunch and the reentry may not be performed by an employee. For example, an employee who uses an in-house restaurant may be present, or an employee who takes a lunch and have it at his/her own seat or the like may be present.

By the way, in recent years in Japan, maintenance of the Laws in regarding to working style reform is improved, and in response to a “working style reform” propelled by the Japanese government, each company or the like introducing various types of work style are being devised, planned, and executed, for example, by introducing a discretionary worker by a job type, or by considering an introduction of a scheme in which various ways of operation can be selected depending on individual circumstances of workers. Further, it is expected that newer working forms will be performed in the future.

For example, workers in the child-rearing generation have traditionally been engaged in so-called reduced working hours (shorter working hours), which is typified by late attendance and early leaving. However, in the future, it is conceivable that there may be a work style in which employees leave work early due to reduced working hours, take care of their children at home, and then work for several hours late at night.

In this case, the time from leaving early to starting work at home can only be regarded as non-working time. It is neither a restraint time nor a break time. This is because the working hours at home may or may not occur depending on whether or not the person works at home (whether or not he/she can). If the person work from home, there will be two sets of attendance and leaving times.

Also, for example, the following work styles can be considered. At restaurants, etc., employees work from early morning purchase to preparation time, for example, from 4 a.m. to 7 a.m. and leave the office once. The employee then goes to work again during the daytime when the store is busy, working from 11:00 a.m. to 14:00 p.m., for example, and leaving again. The employees will go to work again in the evening.

Also in this case, it may be appropriate to consider that the time period between 7 a.m. and 11 a.m. and between 14 o'clock and late in the evening is not a restraint time but out of a working hour. This is because, if the time of the interval of the work is set as the constraint time, the work time in one day is extended over a long time of 12 hours or more, resulting in unreasonable. In this case as well, any work may be started and put out of place according to the situation, not only at a scheduled time but also in accordance with a situation. In this example, there are 3 sets of attendance times.

Furthermore, at present, for example, there are some cases where a system is implemented in which a discretionary labor system is applied to workers in creative occupations and a predetermined wage is paid regardless of actual working hours. However, there are some people who regard this as a social problem because it may still be an incentive for long overtime work. As a solution to these problems, it is possible that eventually the actual time of attendance and leaving will be properly grasped and the relationship with compensation will be negotiated in some way.

In such a worker of a more creative job type, there is also considered a work pattern in which a worker performs a business operation using a portable terminal or the like while changing work place or moving at time.

For example, it is assumed that a new idea is obtained while walking on a street. Then, the worker immediately enters into a nearby coffee shop, and input the new idea into a portable terminal with taking an “attendance” procedure, and when a related routine is completed, a “leaving” procedure is once taken, and then, the worker takes a rest, or out of the house and move to anywhere.

In this case, the “attendance” and “leaving” procedures may be, for example, a “login” operation and a “logout” operation to the portable terminal, or a “login” and a “logout” operation for accessing the server. Of course, it goes without saying that a method involving a dedicated procedure operation may be used separately from the simple login and logout operations.

After that, it is assumed that the idea is expanded or a new idea for another responsible business job is sprung, so that the next business is desired to be started. In a situation in which it is possible to work in place, it is conceivable that the work is carried out by taking an “attendance” procedure, and taking a “leaving” procedure after completing the work, then taking a rest or go out of the store. In that way, it is also considerable that the work is carried out by taking some of times divided in one day, in near future.

In that case, the interval between one work and the next may be as long as 10 to 15 minutes, and the interval may be several hours or more, or even across days. Therefore, the length of time between each work is not fixed, and it is unreasonable to regard it as a restraint time or a break time. Therefore, it is considered that the time zone of the “interval” of the plurality of work hours can only be regarded as the time other than the work hours.

Further, when diversification of employment mode of employees is more improved, it is expected to increase the employers that allow the employees to have a sub-business or a side business. When an employee has a sub-business, he or she works in the morning, for example, as an employee of a main job company A, and goes out at noon. In the afternoon, the employee takes attendance procedure to work as an employee of a sub-business company B and take a work, and in the evening, the employee takes leaving procedure to exit the sub-business company B. It is also conceivable to take a work style such as, for example, revisiting an employee as an employee of the company A, working for several hours, and then leaving a work.

In such a case, the attendance management system in the business company A in which an employee works for main business does not treat the time in which the employee is working at the business place of the business company B as a side business as the target of the business management of the business company A, or as the target of the portal-to-portal hours of the company A. Thus, the Company A, which is for the main business of the employee, treats the employee's work on that day as two times of attendances and leavings. Therefore, in this case, the attendance time and the leaving time of the employee are managed as two sets.

Note that such a working style is also applicable to workers who are so-called “tele-worker(s)”.

In recent years, the number of workers who work at home or in so-called “satellite offices” without going to any of the offices is increasing. Such a worker carries a business information processing terminal or the like, operates it, logs in to the server of the company A as the main business, performs a predetermined authentication procedure, and works as a worker of the company A. Then, if the worker takes a predetermined authentication procedure such as logging out of the server of the company A, the worker can leave the company A. Similarly, the worker performs a predetermined authentication procedure such as logging in to the server of company B, and works as a worker of company B. Then, if the worker takes a predetermined authentication procedure such as logging out of the server of the company B, the worker can leave the company B.

Then, if the worker takes a predetermined authentication procedure, such as logging in to the server of the company A in the day, the worker of the company A can attend the company A as an employee of the company A. The worker takes a predetermined authentication procedure such as logout of the server of the company A after working, the worker can leave the company A as a worker of the company A again.

In this way, it could be considered that, even for a tele-worker who does not work on business offices of business companies A and B, it would be possible to work as an employee, with a side business in addition to main business. In this case, the attendance management system of the company A recognizes that, on the same day, there were two attendances and leavings, and manages each of the attendance time and the leaving time.

However, since all of the above-mentioned conventional techniques are based on the premise that one work in one day is assumed, such a situation cannot be dealt with in which there is a possibility that a plurality of times of attendance and leaving are possible in one day, so that the work hours of workers cannot be properly grasped and managed.

Therefore, it is an object of the present invention to provide an attendance management method, an attendance management program, and an attendance management system, which can cope with a work style such as described above, i.e., a work style in which a plurality of times of attendance and leaving are performed at an arbitrary time at the discretion of a worker, not limited to one work in one day.

The attendance management method according to the present invention includes a step of generating a data record for recording an attendance time on a database, and record the attendance time when a worker who attends more than once in one day operates a computer to record an attendance time, or when the computer detects an attendance of the worker, and a step of recording an leaving time in a data record recorded with the latest time of attendance is provided when the worker operates the computer to record the leaving time, or when the computer detects a leaving of the worker.

The attendance management program according to the present invention includes a step of generating a data record for recording an attendance time on a database, and record the attendance time when a worker who attends a plurality of time in one day operates a computer to record an attendance time, or when the computer detects an attendance of the worker, and a step of recording an leaving time in a data record recorded with the latest time of attendance is provided when the worker operates the computer to record the leaving time, or when the computer detects a leaving of the worker.

An attendance management system according to the present invention equipped a computer for performing a method comprising a step of generating a data record for recording an attendance time on a database, and record the attendance time when a worker who attends more than once in one day operates a computer to record an attendance time, or when the computer detects an attendance of the worker, and a step of recording an leaving time in a data record recorded with the latest time of attendance is provided when the worker operates the computer to record the leaving time, or when the computer detects a leaving of the worker.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a configuration example of a time line showing a time and date of an attendance of a worker who can be operated multiple times in one day of the present disclosure, and a data record for recording each of the attendance and leaving times, and a correspondence relationship between them.

FIG. 2A shows a correspondence relationship between an example of a terminal screen and an element of a data record when a current time is registered as an attendance/leaving time by an operation of a mobile terminal or the like.

FIG. 2B shows a correspondence relationship between an example of a terminal screen and an element of a data record in a case where a user manually inputs a time different from a current time by an operation of a PC terminal or the like.

FIG. 2C shows an example of a registration operation screen and an element of a data record in a case where an actual work time is registered separately from the entry/leaving time after the entry/leaving time has been stamped, including other stamping methods.

FIG. 3A shows an example of a setting screen for setting a job ID for each of a plurality of attendances/leavings in one day.

FIG. 3B shows an example of a job ID setting method in which, when a plurality of jobs are processed in one attendance/leaving, and a plurality of job IDs are set for the attendance/leaving.

FIG. 4A shows an example of an input screen which inputs the man-hour for jobs for every job on the basis of the daily total man-hour, and the configuration example of the record in which it corresponds.

FIG. 4B shows an example of an operation in the case of adding a new job on an input screen for inputting a man-hour record for each job.

FIG. 5A shows an example of a management screen in which a list is displayed together with the weekly and monthly totalization values on the basis of the total man-hour for each day.

FIG. 5B shows an example of a management screen in which, when an arbitrary date is selected in the list screen, the selected date and time of day and hour, the job ID, and the man-hours are displayed.

FIG. 5C shows an example of a management screen for displaying monthly man-hour/monthly overtime man-hour in the form of a graph.

FIG. 5D shows an example of a management screen for displaying monthly man-hour/monthly overtime man-hour in the form of a graph.

FIG. 6 shows an example of a management screen for displaying, in chronological order through a year, the monthly overtime hours out of legal stipulated work hours, the work hours on legal stipulated holidays, and the like for each employee.

FIG. 7A shows an example of a flowchart of a software program implementing the attendance management method of the present invention.

FIG. 7B shows an example of a flowchart of a software program implementing the attendance management method of the present invention.

FIG. 7C shows an example of a flowchart of a software program implementing the attendance management method of the present invention.

FIG. 7D shows an example of a flowchart of a software program implementing the attendance management method of the present invention.

FIG. 8 shows a configuration example of an attendance management system for executing a software program for realizing the attendance management method of the present invention.

### DETAILED DESCRIPTION

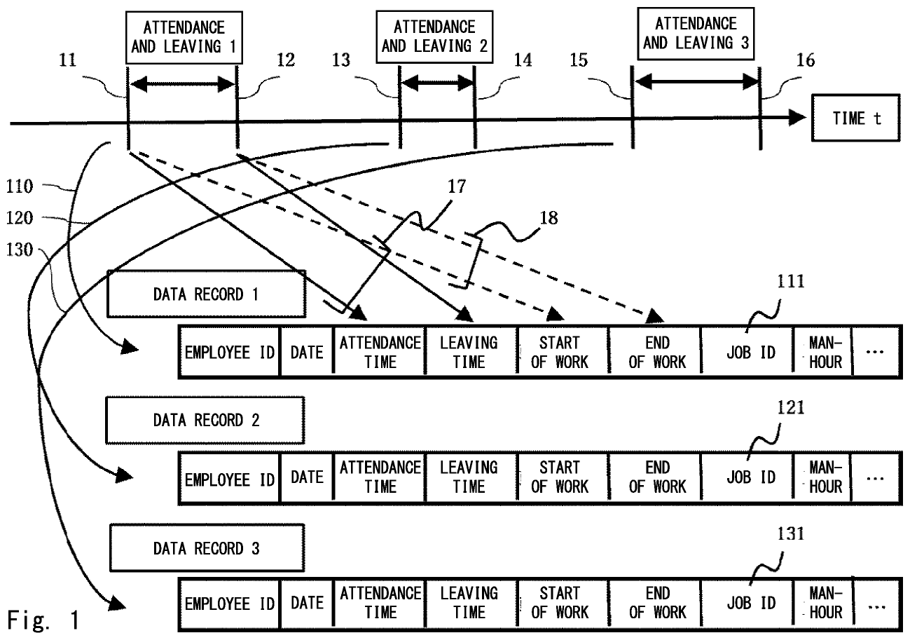

FIG. 1 is a diagram showing an example of a time line showing an example of one day attendance/leaving state of a worker who has a plurality of times of attendance and leaving (exit), a configuration example of a data record on a database (hereinafter, referred to as “DB”) for grasping and recording the attendance time (e.g., time when the worker enters a work place) and leaving time (e.g., time when the worker leaves work or exits the work place) more than once, and a relationship between them.

In the figure, 11, 13, and 15 indicate the attendance times of the worker on a timeline (horizontal axis) representing the elapse of time t of one day of a certain work day, and 12, 14, and 16 show leaving time (i.e., time when the worker leaves a working place).

Further, between 11 and 12, between 13 and 14, and between 15 and 16 show a time zone “attendance/leaving 1”, “attendance/leaving 2”, “attendance/leaving 3”, respectively. That is, this worker, on this day, worked 3 times, shown as an example.

In the present embodiment, the attendance/leaving time is grasped and recorded more than once in one day. Here, since the number of attendance/leaving times in one day of the worker is indefinite, the number of records in which the attendance times are recorded are also indefinite. For this reason, in the data record shown in FIG. 1, there are no 3 data records in advance. For example, each time an attendance of a worker is grasped by the system, it is possible to newly generate and record the time of attendance/leaving on the DB.

An arrow 110 in FIG. 1 indicates that a data record 1 of the work management data TBL (hereafter, TBL is used as an abbreviation of “Table” and the table is used as an abbreviation for the data table included in the DB) is generated for the attendance/leaving 1.

Similarly, arrow 120 indicates that data record 2 has been generated in correspondence with attendance 2, and arrow 130 indicates that data record 3 has been generated for attendance 3.

In addition, in the data record shown in FIG. 1, a set of “start of work” and “end of work” is provided in addition to a set of “attendance time” and “leaving time”, but these may be both performed by a rule of work time management, etc., such as a company implementing the present invention. For example, in a business or the like in which an attendance time is regarded as a work start time. Only the set of “start of work” and “end of work” may be set, and a set of “attendance time” and “leaving time” may not be set in the data record.

A solid arrow 17 and a dotted arrow 18 in FIG. 1 indicate that these variations exist.

A solid arrow 17 indicates that the attendance time and the leaving time of the attendance/leaving 1 are recorded in the “attendance time” and “leaving time” elements of the data record 1, respectively.

This shows an example of the structure of a data record. For example, a company has installed a flapper gate at the entrance and leaving of an office, and adopted a method to grasp the time when an employee holds an employee ID card or a dedicated security card over the card sensor part of this gate as the attendance/leaving time. In this case, the time when the employee passes through the gate is recorded as “attendance time”/“leaving time”. Apart from that, for example, when the employee takes his/her seat and actually starts the work in charge, for example, the time when he/she logs in to his/her PC terminal is recorded as the “start of work” time. In addition, the time when the employee logs out when the work is finished is recorded as the “end of work” time. Alternatively, the time when the employee takes the work start/work end procedure by another method is recorded as the “work start”/“work end” time. The above-mentioned data record configuration corresponds to an example of adopting such a method.

Note that, the “start of work” and the “end of work” time may be configured to be registered each time at the time of attendance/leaving, or may be configured so as to register the “start of work” and the “end of work”, for example, on next day of the attendance/leaving performed.

In this case, in the “man-hour” element of the data record 1, the time from the “start of work” time to the “end of work” time is calculated and recorded as a man-hour when the “work end” time is recorded.

On the other hand, the dotted arrow 18 indicates that the attendance time and the leaving time of the attendance/leaving 1 are recorded in the “start of work” and the “end of work” element of the data record 1, respectively.

In this case, for example, the present disclosure is applied to a company or the like which treats the time of attendance/leaving as the time of “start of work” and “end of work” respectively. In this case as well, it is possible to configure such that, when the work end time is recorded in the “end of work” element of the data record 1, the time from the “work start” time to the “work end” time is calculated and recorded in the “man-hour” element as the man-hour.

Note that, in this case, it is needless to say that the “attendance time” and “leaving time” elements of the record 1 need not be included in the record.

Further, for example, the “employee ID” may be linked with the ID information of the employee data registered in advance in the “employee data TBL” provided separately instead of the configuration included in the data record, so that it is possible to grasp which of the attendance and leaving data records is to be treated.

Thus, there may be many variations in the configuration of elements of the data record, and is not limited to the configuration disclosed in FIG. 1.

As described above, when the attendance and leaving are recorded more than in one day and a plurality of data records are generated, the total man-hour of the day can be calculated by totaling the value of the “man-hour” element recorded in each data record.

Needless to say, it is possible to calculate the total man-hour of the work day without having “man-hour” elements in each data record. If data extraction and calculation processing functions, such as a query of DB, are used, it is also possible to calculate the total man-hour of the day by referring to the time information recorded in the start of work element and the end of work element of each data record belonging to the day.

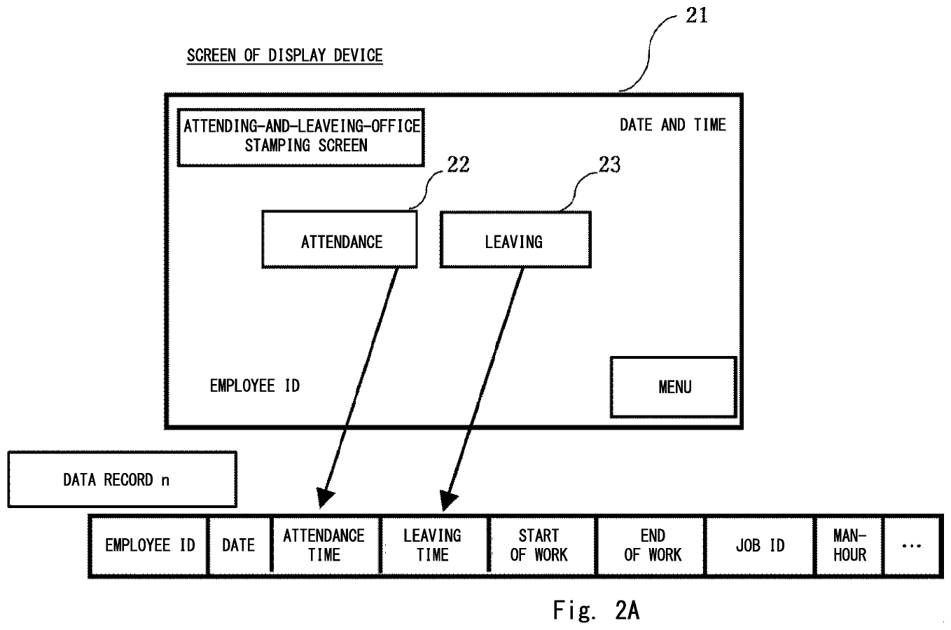

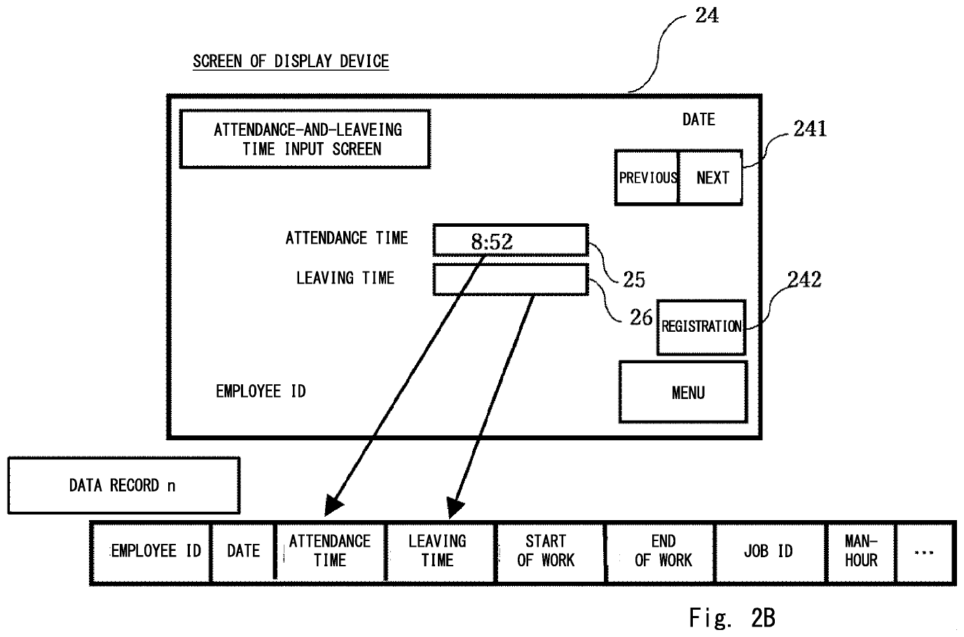

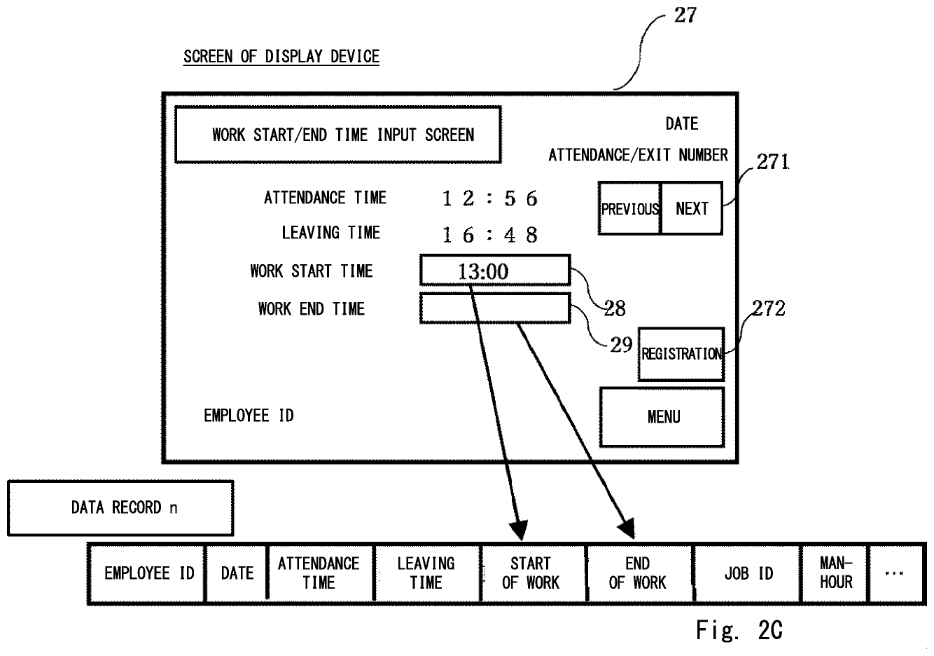

FIGS. 2A to 2C illustrate a specific method for recording time information on each element of any of the data records of FIG. 1 (generally denoted as “data record n” in FIGS. 2A to 2C), “time of attendance”, “time of leaving”, “start of work”, and “end of work”.

FIG. 2A shows an example of a case in which an employee has stamped out an attendance/leaving time from an outside of an office such as where the employee has gone to or the employee's home.

The employee can stamp “attendance time” and “leaving-the-office time” from external, such as a place where the employee has gone to or the employee's home, using information terminals currently brought, such as a smart phone, smart watch, a tablet computer, and a mobile PC.

That is, it is possible to configure the system when a predetermined authentication procedure, such as an employee or the like operating the information terminal and logging in to the DB server of the company via a network, regardless of whether it is wireless or wired, is performed, a menu screen (not shown) is displayed, and when an “attendance/leaving” menu is selected, the operation screen 21 in the drawing is displayed.

By a tap or a click operation (hereinafter, referred to as “click or the like”) is performed on either an “attendance” button 22 or a “leaving” button 23 displayed on the display screen 21, a data record of its own DB server is registered the time of operation as a “time of attendance” or a “time of leaving” in the data record, via a network.

It should be noted that this method is not limited to the case where an “attendance time” or a “leaving time” are stamped from outside of an office such as where the employee has gone to, and may be performed in the company or on the screen of the PC terminal of the employee's own seat. In addition, a computer may detect an attendance or a leaving of the employee or the like and register the attendance time and the leaving time in the data record. For example, if a computer detects attendance and leaving the office using a camera, a flapper gate, a security card, etc., the time of detection will be registered into data record as an attendance time or a leaving-the-office time.

FIG. 2B is a view of a case in which mainly the PC terminal screen of the home seat in the office, the scene when an employee registers an attendance time or a leaving time, but the present invention is not limited thereto. The point is that a time different from a current time is registered as an “attendance time” or a “leaving time” by manual operation.

For example, in a case where a business operation is performed immediately by an attendance and a registration procedure should have done at the attendance time is forgotten, or when a registration procedure of a leaving should have done at the time of leaving on last day is forgotten, it becomes necessary to register a time different from a current time. FIG. 2B shows an example of a method of inputting attendance/leaving time corresponding to such cases above.

In this case, it is possible to configure when a predetermined authentication procedure, such as an employee or the like operating the information terminal and logging in to the DB server of the company, has passed, a menu screen (not shown) is displayed, and when a “attendance/leaving time input” menu is selected, it is possible to reach the screen shown in the figure. In the figure, an employee or the like can register his/her own attendance/leaving time by inputting a time in the attendance time input column 25 displayed on the display screen 24 and the leaving time input column 26 and click or the like, the registration button 242.

In addition, for example, in the case where it is desired to register an arbitrary attendance/leaving time of an arbitrary day before the previous day, it is possible to make the destination date valuable by click or the like, a “previous”, “next” button 241 on the screen 24.

When a “registration” operation including an attendance time is performed on this screen, a new attendance data record is generated on the DB, and the attendance/leaving time is recorded.

FIG. 2C shows a method of manually registering “start of work”/“end of work” in a state in which the attendance/leaving time has already been registered, unlike FIGS. 2A and 2B.

For example, a company installs a flapper gate facility at the entrance/leaving of an office, and employees hold an employee ID card or a dedicated security card over the card sensor part of this gate to grasp the entrance/leaving time. The method is adopted in which the data of the entrance/leaving time grasped in this way is recorded in the “attendance time”/“leaving time” element of the data record. It is assumed that such a company or the like adopts, for example, a method of registering the start time and end time of the previous day's work by a self-report system after the fact.

In this case as well, it is possible to configure when a predetermined authentication procedure, such as an employee or the like operating the information terminal and logging in to the DB server of the company, has passed, a menu screen (not shown) is displayed, and when a “Start of work/end of work time input” menu is selected, it is possible to reach the screen 27 of FIG. 2C. In the figure, a time is inputted into the work start time input column 28 and the work end time input column 29 while referring to, for example, the time of the attendance and the time of the leaving of the previous day displayed on the display screen 27, and by click or the like, a “register” button 272, the employee and the like can register the start time and the end time of the work on the previous day.

Here, for example, when a plurality of times of attendance/leaving on a previous day, it is necessary to select which times of attendance data to be input. Therefore, on the screen 27, there is displayed an “attendance/leaving number”, and a “previous” and a “next” button 271 are provided so as to be able to forward and backward the number. By click or the like, on the “previous” or “next” button, the “attendance/leaving number” is increased or decreased, so that it is possible to access data of a desired attendance/leaving number.

Further, for example, in a case where an arbitrary work start/end time is desired to be registered on an arbitrary day before the previous day, by click or the like, a “date” display portion on the screen 27 and get it selected, a “previous” or “next” button 271 can be clicked or the like, so that the date can be moved back or forth.

In this way, data of each element of “attendance time”, “leaving time”, “start of work”, and “end of work” can be grasped and registered in various ways.

Needless to say, the method is not limited to the 3 examples described above, and may be configured by more various methods.

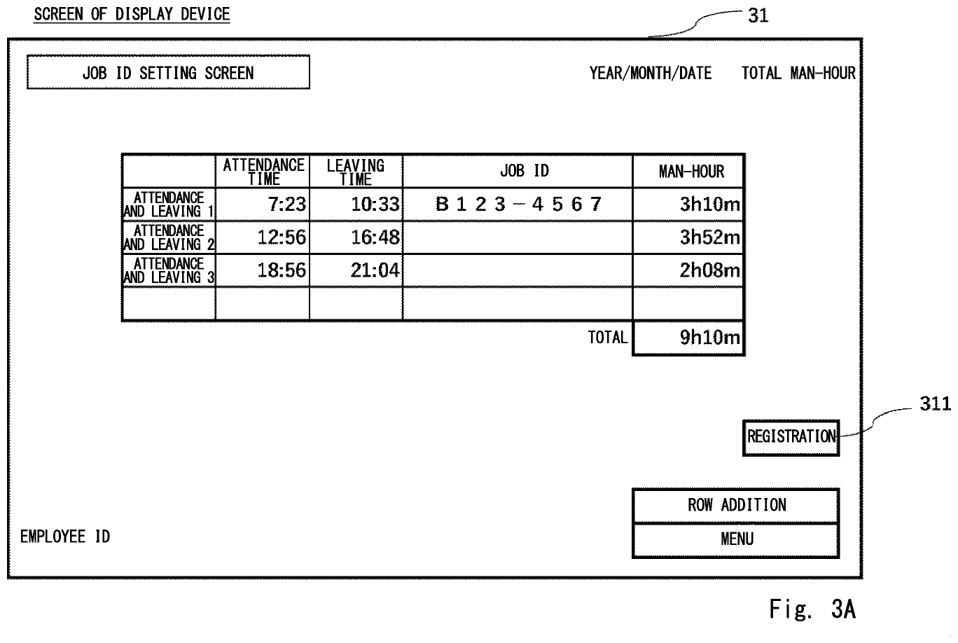

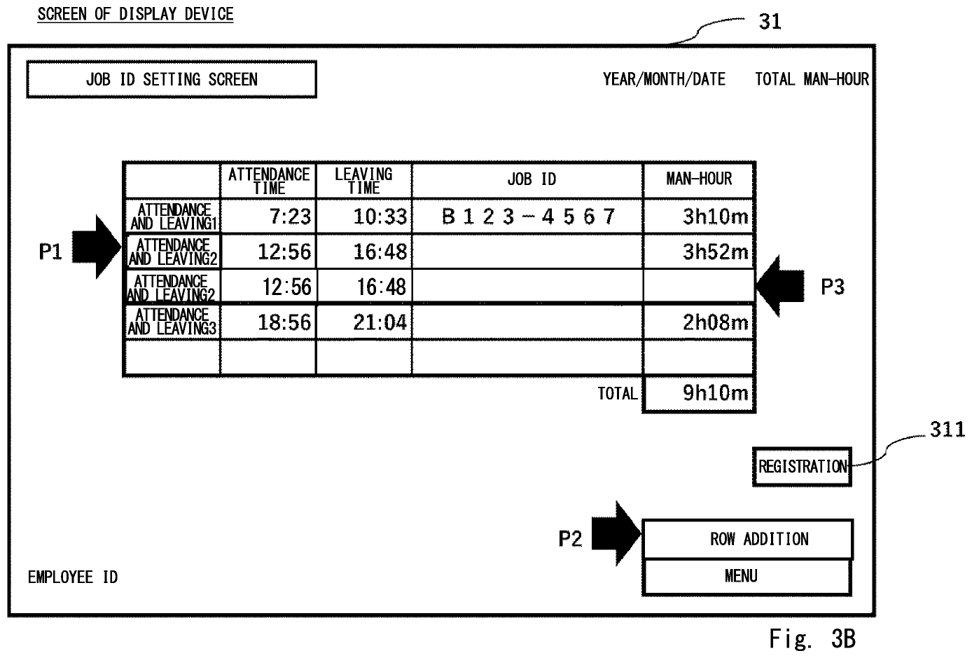

FIGS. 3A and 3B illustrate a method of registering some job IDs in the “job ID” elements 111 to 113 of the data records 1 to 3 of FIG. 1. In this case as well, a menu screen (not shown) may be displayed when a predetermined authentication procedure, such as an employee or the like operating an information terminal and logging in to a DB server of its own company, is performed, and when a “Job ID setting” menu is selected, a screen shown in FIG. 3A may be reached. In FIG. 3A, it may be configured for an employee or the like to be able to input a “job ID” (in this example, “B123-4567” for attendance 1) which corresponds to job in accordance with the content of the task performed by the employee, etc., in the “job ID” column, which corresponds to “attendance 1”, “attendance 2”, and “attendance 3”, displayed on the display screen 31.

Upon completion of setting a job ID for each of attendance/leaving of work, an employee or the like clicks or the like, the “registration” button 311 on the screen 31 to confirm the set job ID. Thus, the set job ID is recorded in the job ID element of each data record on the DB.

Here, there may be cases in which a plurality of tasks corresponding to a plurality of jobs are performed in one attendance. A method for coping with this case is illustrated in FIG. 3B.

In FIG. 3B, for example, in the case of performing the operations corresponding to 2 (two) jobs in the attendance/leaving 2, in order to register the 2 (two) job IDs for the attendance/leaving 2, the row of “attendance/leaving 2” is increased to 2 (two) rows, and the job ID is registered in each.

Specifically, a selection operation is performed by, for example, clicking or the like, on a portion of “attendance/leaving 2” indicated by the arrow P1 in the FIG. 3B. Then, the selected “attendance/leaving 2” is displayed so that it can be determined to be selected by changing color, for example. Subsequently, when a “row addition” button indicated by the arrow P2 in the FIG. 3B is clicked or the like, the row indicated by the arrow P3 in FIG. 3B is added, and the row indicates another “attendance/leaving 2” is further added. In this row, the job ID of the second job is registered.

In this example, the “attendance time”/“leaving time” added to the row of “attendance/leaving 2” have been copied at the same time as the original “attendance/leaving 2”. Referring to this, an employee or the like inputs a job ID of a work into the job ID column of each row, and inputs the man-hour to each of the jobs into the respective “man-hour” column. At this time, the value displayed in the “man-hour hour” column of the original “attendance/leaving 2” needs to be modified. This displayed value may be overwritten by an operation of an employee or the like to input the number of hours of the work of the job ID.

In addition, in the case where a job corresponding to a larger number of jobs is performed in one attendance/leaving, it is possible to further perform a “row addition” operation by the above-described method and to input the job ID to each row.

In this case as well, upon completion of the setting of job ID and the value of man-hour, an employee or the like clicks or the like, the “Registration” button 311 on the screen 31. It goes without saying that the system may be configured to generate a new record on the DB according to the number of rows of attendance set on the screen 31 when “registration” operation is executed.

Since the total man-hour of the attendance/leaving 2 can be calculated by the “attendance time” and “leaving time” of attendance/leaving 2, the system can determine whether or not the sum of the man-hour in the multi-rows coincides with the total man-hour of the attendance/leaving 2. The display device displays information for paying an attention to employees or the like when the total man-hour does not coincide with that of attendance/leaving 2.

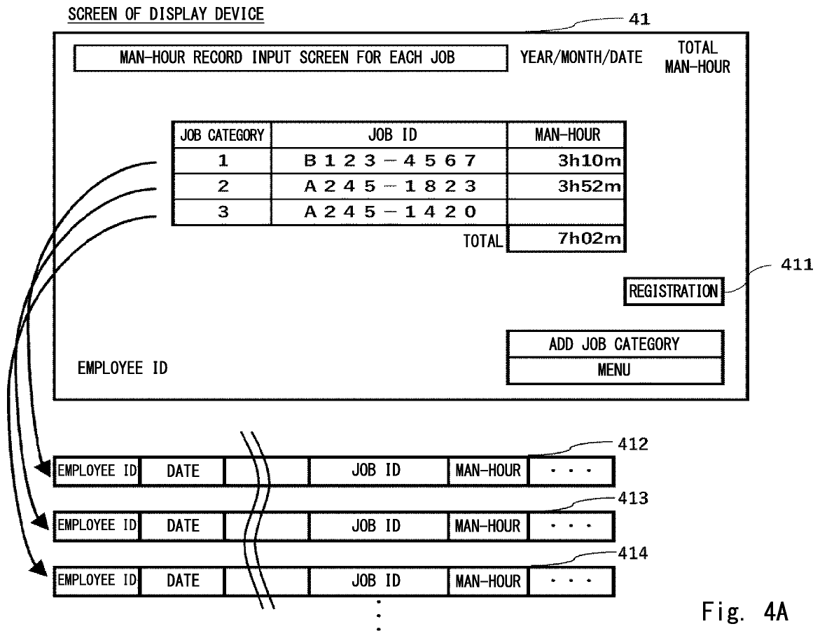

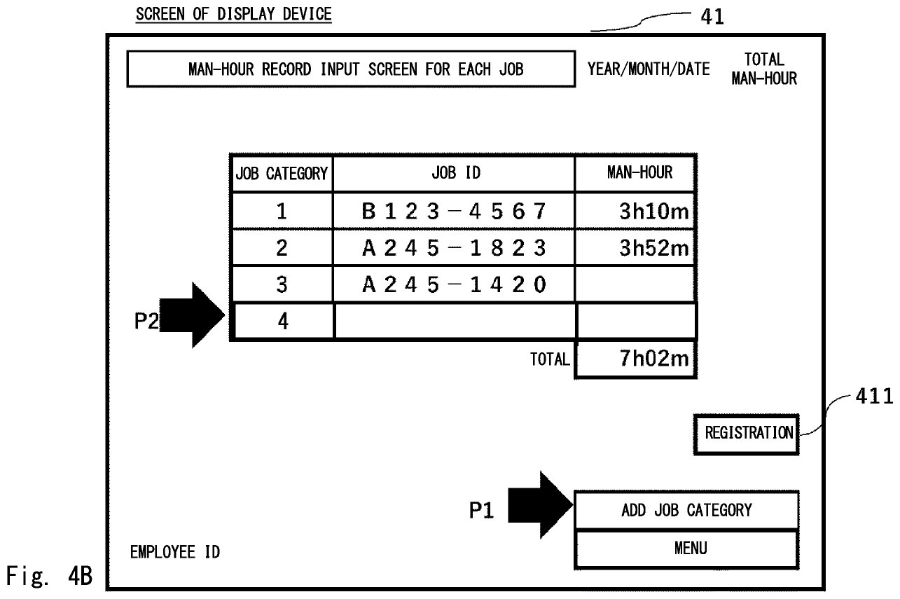

FIGS. 4A and 4B illustrate a method of registering a job ID different from that described in FIGS. 3A and 3B. In other words, FIGS. 3A and 3B show a method in which, for a plurality of attendance/leaving operations in one day, the job ID and the man-hour data are recorded in the form of “attendance/leaving” unit in the form of “one work and one job in one record”, whereas FIGS. 4A and 4B show a method in which, on the basis of the sum of man-hours of one day (hereinafter, referred to as “total man-hour”), the data “man-hour per a job” is grasped and recorded in the form of “one day and one job in one record”, which registers the job ID and the man-hour data on the basis of how many hours the business has been performed in one day basis.

In this case as well, the configuration of FIG. 1 is applied in that the total man-hour of one day can be used as a basis, which can be calculated from the “attendance” data recorded in the form of “one work and one job in one record”. However, in the method of FIGS. 4A and 4B, when the man-hours per a job is grasped, it is not necessary that the data record of FIG. 1 includes elements of the job ID and the man-hour, and as shown in 412 through 414 in FIG. 4A, data records different from those shown in FIG. 1 are generated for each job and the man-hours are managed in units of jobs.

FIG. 4A shows an example of a “man-hour record input screen for each job” in which the job ID and the man-hour to be assigned to the job are registered based on the job categories. In this case as well, a menu screen (not shown) is displayed when a predetermined authentication procedure is performed so that an employee or the like operates an information terminal to log in to its DB server, for example. Then, when a menu “Entry of a man-hour for each job” is selected, it is possible to reach the screen of FIG. 4A.

In FIG. 4A, a list consisting of a job category column, a job ID column, and a man-hour column is displayed on a display 41, and “year, month, date” indicating which of the work days is displayed and “total man-hour” of the date, and “employee ID” indicating an employee and the like in charge are displayed.

In general, since there is not always one job to be processed by an employee or the like in one day, a frame of 4 or 5 rows may be displayed from the beginning for convenience of the registration operation.

When, on the screen 41, the number of executed jobs is greater than the number of displayed rows, for example, an “Add job category” button indicated by the arrow P1 in FIG. 4B is clicked or the like. A row of a job category “4” indicated by the arrow P2 in the FIG. 4B may be additionally displayed.

In addition, when more job categories are added, for example, the number of rows which can expand the table on the display may be up to 5 lines, and the number of rows may be increased up to more than 5 rows, so that, for example, in the display range of the 5 rows, the user may be able to scroll up and down in the displayed range of the screen.

In FIGS. 4A and 4B, an employee or the like inputs the job ID in the “job ID” column of the list, and inputs the man-hour in the man-hour column. When a registration operation is performed by clicking or the like, on a “registration” button 411, a necessary number of jobs of data records on the DB may be generated in accordance with the number of jobs to be entered at that time. The data may be recorded in each element of the employee ID, date, job ID, and man-hour.

The attendance management of employees, etc. based on the technology to grasp, record, and manage the attendance/leaving data of every day of employees, etc. who may work more than once in one day is described above. One of the functions required here is man-hour progress management based on total man-hours for each employee.

In other words, a monthly list of man-hours may be displayed for each employee, or may be displayed in a graph format so that a situation can be visually grasped. Also, the fluctuation of the monthly time of overtime work may be displayed in a list or may be displayed in a graph format.

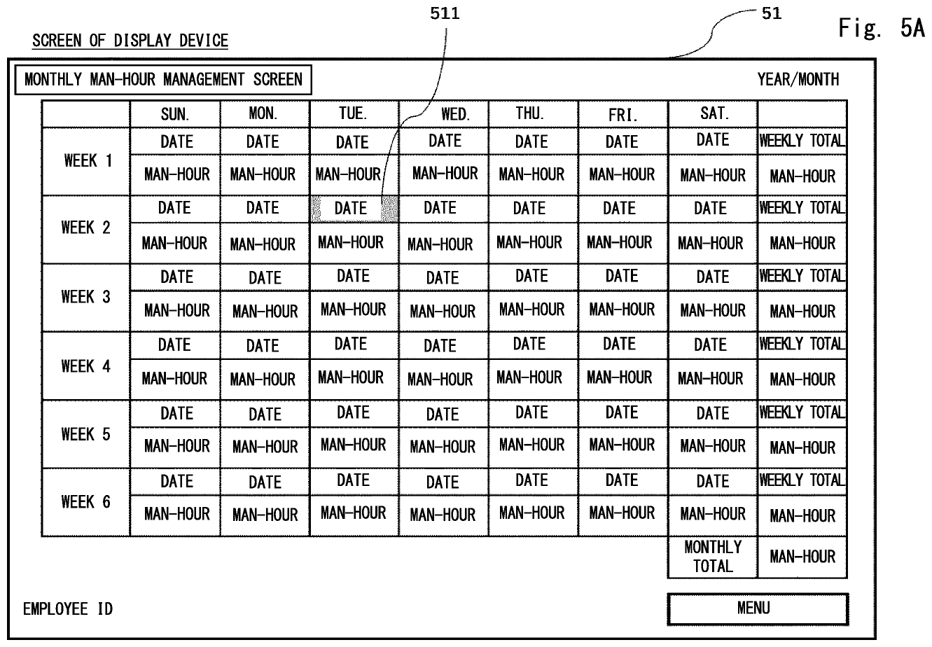

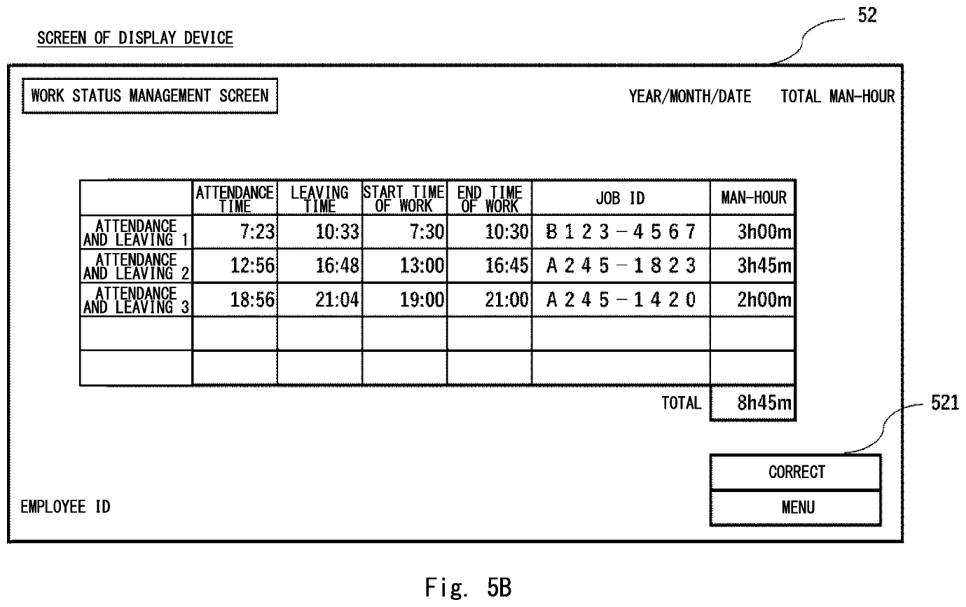

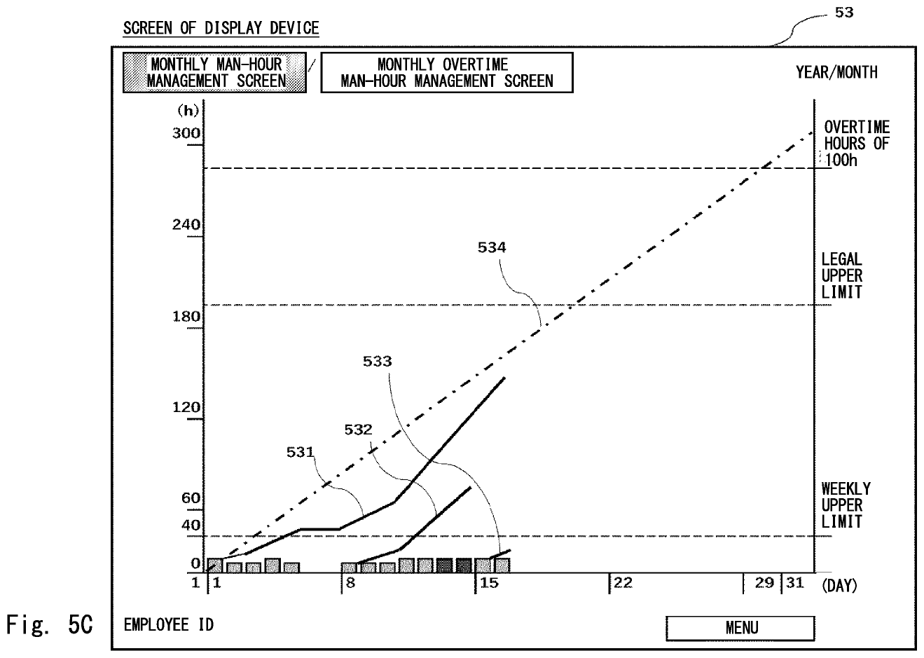

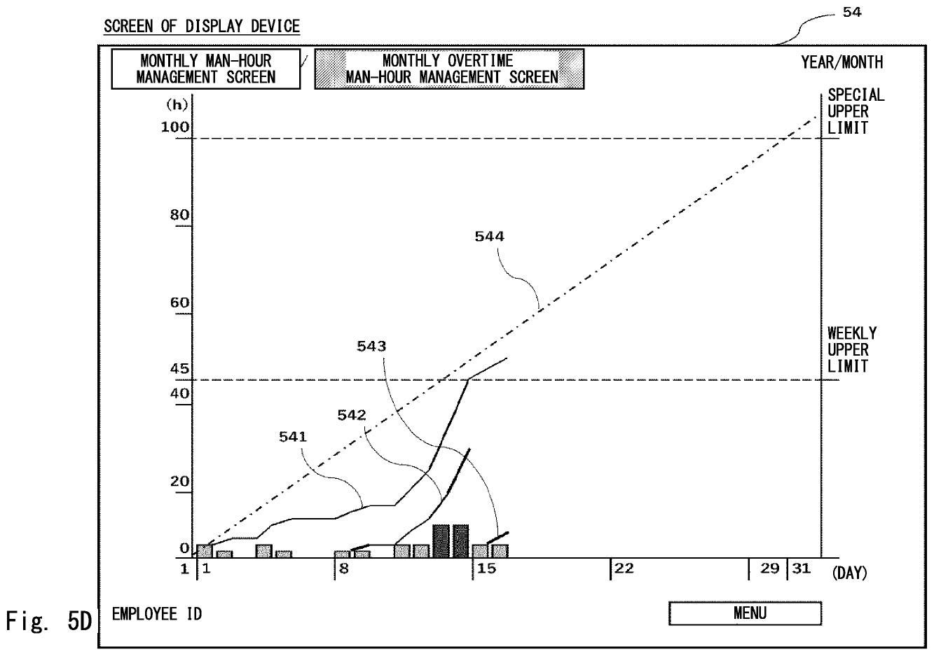

FIG. 5A shows an example in which the total man-hours for each employee are displayed in a list of days. The weekly totalization value and the monthly totalization value are displayed together. In this case as well, a menu screen (not shown) can be displayed when a predetermined authentication procedure is performed so that an employee or the like operates an information terminal to log in to its DB server, for example. Then, when a “monthly man-hour management” menu is selected, it is possible to reach the screen of FIG. 5A. The screen 51 indicates a “monthly man-hour management screen”, and lists of daily total man-hours are displayed. For example, in addition to this, the display device is configured to display an aggregate value per day of the week.

According to this display screen, it is possible for the administrator to see a daily man-hour distribution, to read a busy situation per week, and to read the amount of man-hour per day of the week.

Here, for example, there is a case where it is desired to confirm the breakdown of the Tuesday in the Week 2. The man-hour of the Tuesday in the Week 2 is much higher than other days. At this time, when the user selects a date column of Tuesday in the Week 2, which is indicated by 511 in FIG. 5A, by clicking or the like, FIG. 5B is displayed.

In FIG. 5B, on the screen 52, the situation of the attendance, the start/end time of work, the job ID of the executed work, and the man-hour on the selected day are displayed, and a specific breakdown can be confirmed. In this way, it is possible to read out how the attendance/leaving is done, and, the status of the work hours, the contents of the work, and the man-hours in each attendance.

FIGS. 5A and 5B may be used not only for the administrator to browse for management purposes but also for an employee to see his/her work status for confirmation. For example, when the employee browses the list display screen 51 of FIG. 5A in order to view the work status of the current month, the employee can recognize the contents on the screen 52 of FIG. 5B by selecting the date when the man-hour of the Tuesday of the Week 2 is much larger or smaller than his/her remembrance.

In addition, if some error or the like is found in the registered data, the data registered in the corresponding data record can be corrected and updated by selecting the cell in the table to be corrected, and by appropriately updating the data and clicking or the like, the “Correct” button 521.

FIG. 5C shows an example of a display screen in which the list display format of the monthly man-hour management screen of FIG. 5A is displayed in a graph format. In this case as well, when a predetermined authentication procedure is performed by an employee or the like by operating the information terminal to log in to its DB server. Then, a menu screen (not shown) is displayed. It is possible to reach the screen shown in FIG. 5C when a “monthly man-hour management (graph display)” menu in the menu screen is selected,

For an employee specified by “employee ID” at the lower left of the screen 53, the total man-hour for each day is indicated by a bar graph from the first day of the month displayed in “year and month” at the upper right of the screen, and the cumulative value of each day is displayed by a fold line graph 531. In this example, data up to the day 16 of the current month is displayed. That is, the screen is displayed and browsed at a certain time on the day 17 of the month.

In this example, a month having Monday as the day 1 of it is illustrated. In other words, the day 6 is Saturday, the day 7 is Sunday. In the exemplified company or the like, those days are assigned as holidays and there is no attendance. Therefore, a total man-hour is 0 (zero). On the other hand, regarding the day 13 of Saturday and the day 14 of Sunday, since they made attendance on holidays, the total man-hour has been increased. In this example, the color of the bar graph is changed so that it can be determined that they have attended on the holidays.

The fold line graph 532 shows the fluctuation of the amount of total man-hour of the week 2. In order to read only the fluctuation of week 2, the fold line graph 532 is stopped until day 14 of the month. In order to grasp the relationship between total working time of this week and the regulatory value of the legal limit of working time in one week, a line representing an “upper limit of a week” is displayed with a horizontal line at a height of 40 h on the vertical axis. The fold line graph 532 can be read as exceeding this.

Similarly, the fold line graph 533 shows the progress of the total amount of the total man-hour in the week 3.

Here, only the fold line 531 of the week 1 is drawn for the purpose of displaying the cumulative progress of the month, the line is also drawn on and after week 2. It is configured to easily read the fluctuation of fold line 531 against to a line representing a legal upper limit of work hours of a month and a line indicates the overtime work of 100 h.

In this example, a graph 534 is displayed to expect how much the man-hours at the end of the month will increase when an average value obtained by dividing the total man-hours up to the day 16 of the month is continued until the end of the month. In this case, it is possible to read out the progress of the man-hour at a pace which can reach the line of the overrun 100 h until the end of the month.

FIG. 5D shows a “monthly overtime work man-hour management screen” in which the color is displayed in the upper portion of the screen 54 with changing the color. In this case as well, when a predetermined authentication procedure is performed by an employee or the like by operating the information terminal to log in to its DB server, a menu screen (not shown) is displayed, and when a “monthly overtime hours management (graph display)” menu is selected, it is possible to reach the screen shown in FIG. 5D.

FIG. 5D graphically shows only the overtime hours included in the total man-hour of FIG. 5C. Accordingly, the time of the vertical axis is changed from that shown in FIG. 5C. The control value display line is also set to the “upper limit of a week” 45 h and the “special upper limit” 100 h regarding the overtime hours.

In each graph, only the overtime hours are extracted and represented as shown in FIG. 5C. In other words, the worker did not work on the day 6 and the day 7 of the month because these days are holidays of Saturday and Sunday. There is no overtime hours in these days. On the other hand, the worker worked on the days 13 and the day 14. The total man-hours are counted as the overtime hours, and all the hours are displayed. Thus, the fold lines 541 and 542 show a rapid increase on Saturday and Sunday of the days 13 and 14. The fold line graph 543 shows a cumulative fluctuation of the overtime hours in the week 3.

In FIG. 5D, a graph 544 is displayed for estimating how much the overtime hours will increase until the end of the month, when an average value is continued by end of the month. The average value is obtained by dividing the total overtime hours up to the day 16 of the month by the number of elapsed days. According to this, it is possible to read out that the overtime hours is fluctuated at a pace which exceeds the line of the overrun 100 h as the “special upper limit” until the end of the month.

By the way, in the example in FIG. 5D, the fold line graph indicates that the total overtime hours rise to right. However, when the worker can attend at and leave from the office at any time at workers' discretion in the future, the cumulative value of overtime hours will not be restricted only to rise to right. The graph may rise and fall in accordance with a working situation.

For example, it is also conceivable that a monthly sum of work hours of a worker will takes a value below a predetermined working time. It is also conceivable that, as can be seen in flex-time-based companies, the shortfall in the month of a given working time may be treated to compensate for the working hours of a certain range of overtime hours and offset them.

In this case, for the offset process between office hours and overtime hours, various methods can be considered, being carried out by daily, being carried out by weekly, or being carried out by monthly. If this is the case of daily or weekly, it is considered that the fold line graph of the overtime hours rises or falls per unit.

In this case, in the present disclosure, the worker's attendance/leaving time data is recorded every time, throughout the time zone of early morning and midnight. In accordance with the regulations of the business rule of the company worker or the like, a normal work hours and overtime hours are calculated. For example, a calculation of the offset between them can be appropriately processed.

In addition, there are several categories of the overtime hours to be managed, and a period and a time limit within the period are generally provided for each category.

As an example of a category, in the Japanese Worker Standard Law, first, working hours are restricted legally. According to this, an upper limit of normal working time in one day at the time of filing of the present application is defined as 8 hours, and a working time in one week is defined as 40 hours. It is defined that working hours exceeding these values must be regarded as the overtime hours of the worker.

It is determined that overtime hours per a week is up to 45 hours and overtime hours per a year is up to 360 hours. And excess is further accepted over 45 hours of a month as upper limit in case of applying a special clause up to 6 times per year. The sum of the work hours and overtime hours of the month average is up to 80 hours over an average of 2 to 6 months, and the sum of the work hours and overtime hours is up to 100 hours. And a total overtime hours of a year is defined as 720 hours. (At the time of writing this specification, the value of the worker time limit defined in the Japanese Worker Standards Law is defined as the above values.)

The “weekly upper limit”, “legal upper limit”, “overtime hours of 100 h” of the monthly man-hour management screen illustrated in FIG. 5C, and “weekly upper limit” and “special upper limit” of the monthly overtime hour management screen illustrated in FIG. 5D etc., exemplify these restriction values.

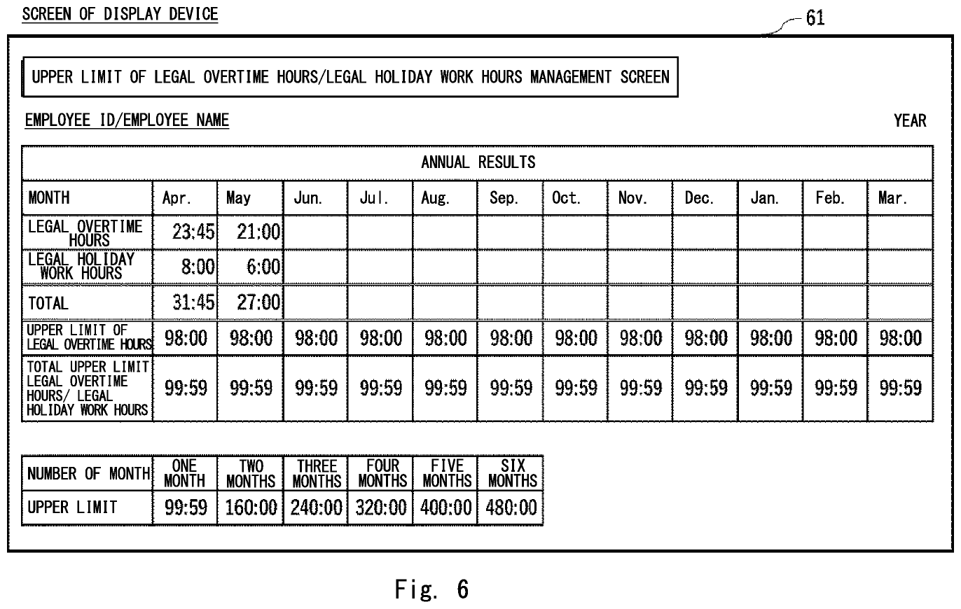

FIG. 6 shows an example of an “upper limit of legal overtime hours/legal holiday work hours management screen” for displaying a list of hours which cannot be managed at monthly basis, and for managing the hours at annual basis. In this case, when a predetermined authentication procedure, such as an employee or the like operating an information terminal and logging in to a DB server of its own company, is performed, a menu screen (not shown) is displayed, and when an “upper limit of legal overtime hours/legal holiday work hours management screen” menu is selected, it is possible to reach the screen of FIG. 6.

On the screen 61 of FIG. 6, for an employee identified by an “employee ID” displayed on the upper left side, and for of the “year” of the upper right of the screen, it is possible to list and manage the legal overtime hours/legal holiday work hours, and the total value thereof.

In addition, regarding to in FIG. 6, in the same way as in the display example shown in FIGS. 5C and 5D with respect to the list display of FIG. 5A, it goes without saying that the fluctuation of the overtime hours can be appropriately graphed and displayed.

### A Description of Operation

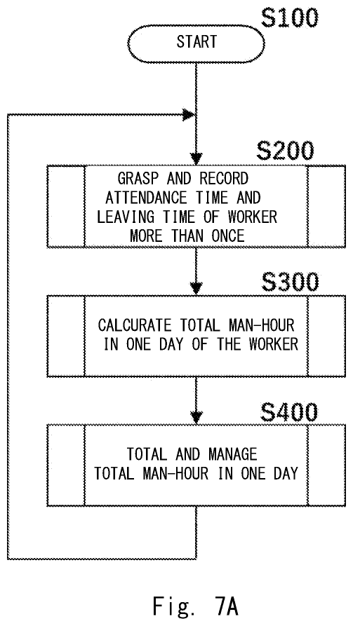

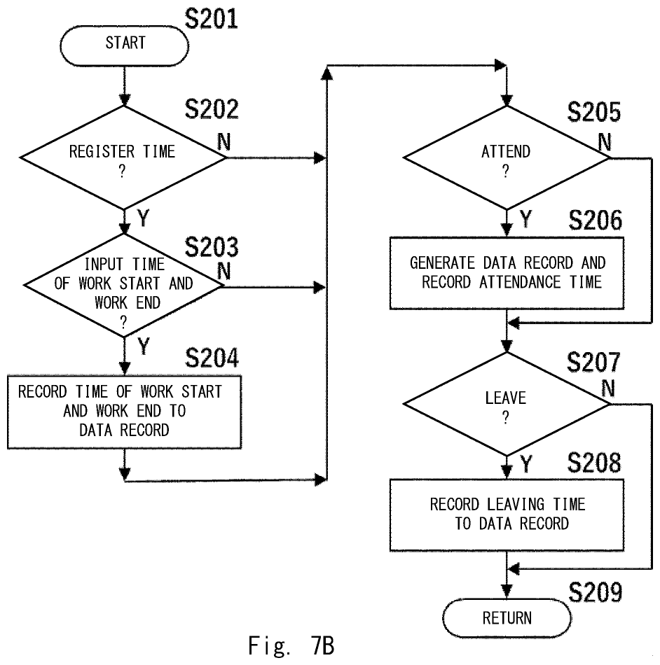

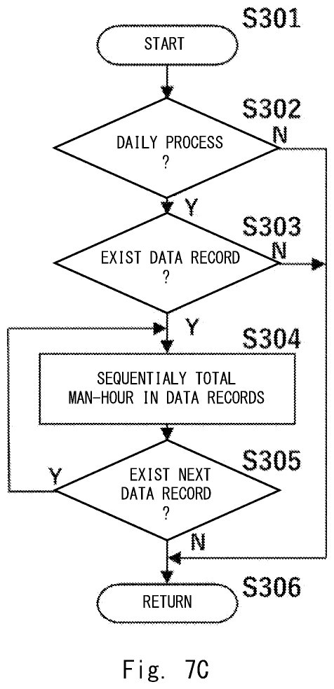

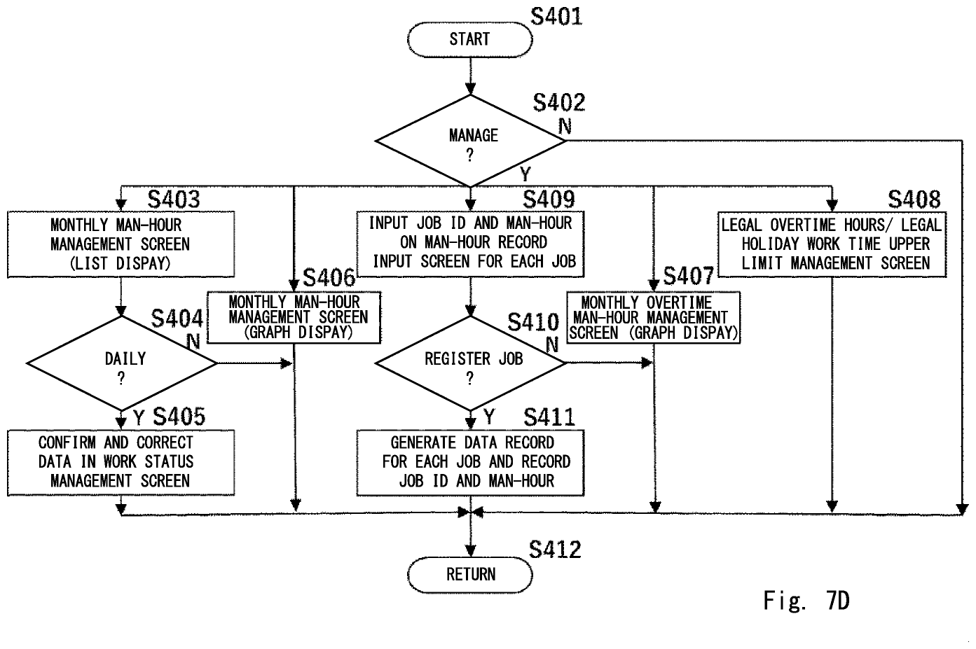

Next, the operation of the attendance management system will be described with reference to FIGS. 7A to 7D. The operation of the attendance management system is applicable to a work style in which multiple attendances and leavings in one day is performed at an arbitrary time at the discretion of the worker. FIGS. 7A to 7D show an example of a flowchart for explaining an operation of the attendance management system of the present disclosure.

Referring to FIG. 7A, when starting execution from Step S100, the control program of the attendance management system according to the present disclosure executes step S200 for grasping and recording attendance time and leaving time of a worker more than once, step S300 for calculating the total man-hour in one day of the worker, and step S400 for totaling and managing the man-hour in one day at Step S400. These steps are repeated continuously.

Here, in FIGS. 7A to 7D, for the sake of explanation, a configuration in which a series of programs is repeatedly executed is disclosed, but this is for an example of a configuration in which can respond without delay when an information terminal operation such as an employee is performed, and the present invention is not limited to such a loop configuration. Under current circumstances, it is generally known that a software program can be configured to detect a user's operation, such as so-called “event-driven”, and to initiate a necessary process according to the content of the operation.

However, when such an arrangement is applied to the description as it is, the flow chart becomes sparse for each event, and the explanation becomes complicated and difficult to understand.

Therefore, in order to facilitate description and understanding of the present specification, an example of a flowchart is shown as software of a more general method of detecting events by a program.

Following description describes an image forming apparatus according to an embodiment of the present invention and a configuration other than the flowchart can be created from FIGS. 7A to 7D showing a flow chart of the present invention. Therefore, the program of the present invention is not limited to the configuration of the flowchart disclosed in FIGS. 7A to 7D, and it goes without saying that the program of various configurations falls within the scope of the present invention without departing from the gist of the present invention.

The step S200 “grasping and recording a plurality of times of attendance and leaving of a worker in one day” of FIG. 7A can be realized by configuring a flowchart shown in FIG. 7B as an example.

That is, it starts from Step S201 and checks the existence of “registration of time” operation at Step S202 first. It is checked whether or not the registration button 242 shown in FIG. 2B and the registration button 272 shown in FIG. 2C have been clicked or the like. If either of them is clicked or the like, step S202 proceeds to “Y”.

Subsequently, in step S203, it is checked whether or not the registration button 272 of FIG. 2C has been clicked or the like. If this is the case, the process proceeds to “Y”, and in step S204, the time set in the work start time input field 28 and the time set in the work end time input field 29 of FIG. 2C is recorded in the “work start time (time of work start)” and the “work end time (time of work end)” element of the data record on the DB corresponding to the date and the attendance/leaving number displayed on the upper right of the screen 27 of FIG. 2C.

When there is no operation of the time registration button in FIGS. 2B and 2C, or when the registration button clicked or the like is 242 in FIG. 2B, or when the recording in step S204 is completed, the process proceeds to step S205. The registration operation of the attendance time by an employee or the like is checked.

This includes the detection of an operation of clicking or the like, an “attendance” button 22 on the screen 21 in FIG. 2A, and an operation of clicking or the like, a “registration” button 242 on the screen 24 in FIG. 2B.

When any of these operations is detected, step S205 proceeds to “Y”. In step S206, a new data record is generated on the DB and the attendance time is recorded in the “attendance time” element.

When attendance operation is not detected, or when registration of attendance times is completed at Step S206, it proceeds to Step S207. The register operation of the leaving-the-office time by the employee or the like is checked.

This includes the detection of an operation of clicking or the like, the “leave” button 23 on the screen 21 in FIG. 2A, and an operation of clicking or the like, the “register” button 242 on the screen 24 in FIG. 2B.

When any of these operations is detected, step S207 proceeds to “Y”. In step S208, the leaving time is recorded in the “leaving time” element. When the “register” button 242 of FIG. 2B is clicked or the like, a leaving time set in the leaving time input field 26 is recorded in the “leaving time” element of the data record.

When a leaving operation is not detected, or when the recording processing of leaving time is completed in Step S208, it proceeds to Step S209. The processing of Step S200 of FIG. 7A is completed.

In next, step S300 “calculating the total man-hour in one day of the worker” of FIG. 7A can be realized by configuring a flow chart shown in FIG. 7C as an example. That is, it starts from Step S301 and the arrival of a time which performs a “daily process” in Step S302 is checked. For example, a timer may be provided in the attendance management system. The daily process may be executed at a predetermined time before dawn every day. The employee can execute the daily process when necessary. If the execution timing of daily process is detected, Step S302 will proceed to “Y”.

In Step S303, it is confirmed whether the attending-and-leaving data record contained on the object day such as that day or previous day of the defined daily process exists. This is because there are some days such as holidays of the company in which there is no attendance data record correspond to an employee or the like.

When a data record to be processed is detected, step S303 proceeds to “Y”. Then, the man-hours recorded in “man-hour” elements of data records is totalized for each employee. The total man-hour of one day for each employee is calculated. This counting process is repeated until no next record is detected in step S305.

For example, as shown in FIG. 1, in the case of an employee who has attended and left three times in one day, the presence of the data record 1 is detected first, whereby the step S303 proceeds to “Y”, and in step S304, the data recorded in the “man-hour” element from the data records 1 to 3 are totalized.

When the total of one day has been calculated in this way, Step S305 proceeds to “N”. The process ends in step S306.

The next, Step S400 “calculating and managing the total man-hour in one day” of FIG. 7A can be implemented by configuring the flowchart shown in FIG. 7D as an example.

That is, starting from Step S401, the presence or absence of a display operation on the “management” screen is checked in Step S402. When any of the management screen display operations is detected, step S402 proceeds to “Y”, the each management screen is displayed according to the display sequence of the selected management screen.

A “monthly man-hour management screen (list display)” displayed in step S403 is the screen 51 of FIG. 5A. Then, in FIG. 5A, when the date 511 of Tuesday of the week 2 is clicked or the like, the operation is detected in step S404 of FIG. 7D. Then, the process proceeds to “Y”. In step S405, the “work status management screen” 52 of FIG. 5B is displayed. In step S405, as described above with reference to FIG. 5B, the registered job ID, the man-hour, and the like are corrected. The data updating of the data record is completed, the process proceeds to step S412 of FIG. 7D. The process is completed.

The “monthly man-hour management screen (graph display)” displayed in step S406 is the screen 53 of FIG. 5C. In order to display this screen, data of daily total man-hours of the employee specified by “employee ID” displayed on the screen 53 is used. As the total man-hour data, the data totalized in step S300 of FIG. 7A may be used. However, for example, the data of the “man-hour” elements of the data records 1 to 3 shown in FIG. 1 may be totalized and be used when necessary.

The “monthly overtime man-hour management screen (graph display)” displayed in step S407 is the screen 54 of FIG. 5D. In order to display this screen, it is necessary to calculate and use the overtime hours on the basis of the data of the daily total man-hour of the employee identified by the “employee ID” displayed on the screen 54.

The “legal overtime hours/legal holiday work time upper limit management screen” displayed in step S408 is the screen 61 of FIG. 6. In order to display this screen, it is necessary to calculate the legal overtime hours and the legal holiday work hours on the basis of the data of the daily total man-hour of the employee specified by the “employee ID” displayed on the screen 61 and use those.

The “Input job ID and man-hour on the man-hour record input screen for each job” of Step S409 refers to the operation for setting job ID and man-hour on the displayed “man-hour record input screen for each job” screen 41 which are described with referring to FIGS. 4A and 4B.

When an employee or the like operates the screen 41 of FIGS. 4A and 4B to input data and clicks or the like, a “Register” button 411, “Registration of a Job” is detected in Step S410 of FIG. 7D, and the process proceeds to “Y”. Thus, in step S411, data records 412 through 414 shown in FIG. 4A are generated on the DB for each registered job, and the input job ID and the man-hours are recorded in the “job ID” and “man-hour” elements of each record. Upon completion of step S411, the process proceeds to step S412, and the process ends.

Returning to FIG. 7A, upon completion of step S400, the control returns to step S200, and the above processing is repeated as described above.

### Example System Configuration

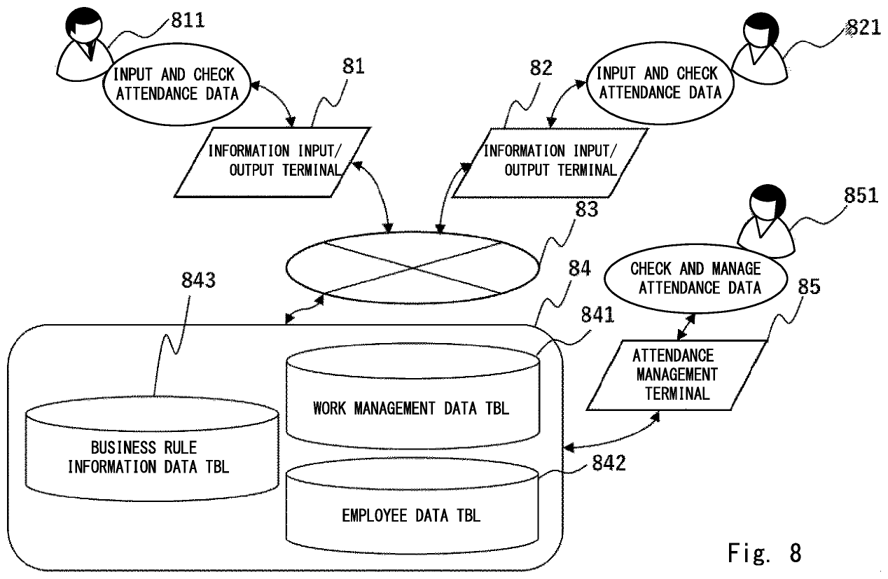

FIG. 8 shows an example of an embodiment of the attendance management system of the present invention.

In FIG. 8, reference numerals 81 and 82 denote information input/output terminals that include a smartphone, a smart watch, a tablet terminal, a mobile PC, and the like held by a general employee, including an in-house worker and an outside-side worker such as a dispatch worker. Employees 811 and 821 are users of the information input/output terminals 81 and 82, respectively. These are not limited to two shown in the Fig., and may be the number of employees. These information input/output terminals are connected to the DB 84 via the network 83. The network 83 may be a general-purpose network such as the Internet. The network 83 may be a dedicated line such as a VPN or the like. The network 83 may be configured by an in-house LAN network or the like in a small-scale system.

The DB 84 may be configured by an information processing system to which a computer is applied, such as a so-called DB server. This system includes at least a “work management data TBL” 841 for recording attendance data, job ID data, various man-hour data, etc., of each employee and the like, and an “employee data TBL” 842 recording information about each employee such as an employee ID and an employee name of each employee and the like, and “business rule information data TBL” 843 recording information such as a business rule of the company or the like.

The attendance management terminal 85 is connected to the DB 84, and is mainly operated by an employee in a management staff department. The attendance management terminal 85 is used for attendance management such as progress management of work hours and overtime hours of each worker. Employee 851 or the like is an employee in the staff department.

In FIG. 8, employees or the like, including staff members in the staff department, registers the attendance time, the work start/end time, and the like in the DB using the information input/output terminals 81, 82 and 85 by the methods shown in FIGS. 2A to 2C. By this operation, data records 1 to 3 illustrated in FIG. 1 are generated. The attendance/leaving time and the work start/end time are recorded, and the man-hour is calculated. In addition, the general employee 811, 821 and the like shown in FIG. 8 can register, by operating the screen 31 shown in FIGS. 3A and 3B, the job ID and the man-hour of the job that has been subjected to the business operation for each of the attendance and leaving.

Further, the general employee 811, 821 and the like shown in FIG. 8 can register, by operating the screen 41 shown in FIGS. 4A and 4B, the job ID and the man-hour for each job that has been executed.

The employee 851 in the staff department shown in FIG. 8 can operate the attendance management terminal 85. Thus, the employee 851 can carry out attendance management task of each employee by referring each management screen shown in FIGS. 5A to 5D and FIG. 6.

Note that each of the management screens shown in FIGS. 5A to 5D, and FIG. 6 can be configured so that the general staff 811, 821 and the like can refer to their own data. Therefore, the general staff 811, 821 and the like can manage the progress of man-hour, the progress of the overtime hours, and the like by themselves. In particular, with reference to FIG. 5A, when an abnormality is felt in data of a certain day, as shown in FIG. 5B, it is possible to confirm and correct it by himself/herself. In addition, in the case where the general employee 811 or 812 has a subordinate, by configuring the system so that the general can refer to the data of the subordinate when the general employee 811 or 812 refers to the data of itself, he/she can manage the progress of the work hours and overtime hours of the subordinate.

Note that the information processing system shown in FIG. 8 can be implemented in various manners.

For example, for accomplishing the current system with a minimum configuration in a small business or the like, all of the functions of the information input/output terminal 81, 82, DB 84 and the attendance management terminal 85 can be implemented in one notebook PC without using the network 83.

Alternatively, in a medium firm company or the like, a server device for an attendance management system is installed in its own company to configure the attendance management system as set forth below. The DB 84 and various calculation processing programs are mounted on the server device. The information input/output terminal 81 and the like are held by a general employee. Thus, it is also possible to configure the system of FIG. 8 by connecting the information input/output terminal to the server apparatus via the network 83 to access the DB 84. The attendance management terminal 85 is installed in the staff department.

Further, in a large enterprise or the like, the DB 84 and various calculation processing programs and the like are mounted on a server on a cloud system provided by so-called cloud service. It is also possible to configure a so-called SaaS (Software as a Service) system so that the information terminals 81 and 82, etc. used by each general employee and the like and the attendance management terminal 85 and the like used by employees in staff departments are connected to the server via the network 83.

### The Second Exemplary Embodiment

The above-mentioned technique for grasping, recording, and managing daily attendance/leaving data of employees who may work more than once in one day is described above. There is an attendance management method for the employee, etc., based on this. One of the functions required here is man-hour progress management for each job.

In other words, a monthly list of man-hour progressions may be displayed for each job, or may be displayed in a graph format so that a situation can be grasped more visually. Also, the fluctuation of the monthly overtime hours may be displayed in a list or may be displayed in a graph format.

In this case, a daily man-hour for each job, which serves as a basis for configuring a display, can be obtained in the manner described in FIGS. 4A and 4B.

That is, for each of the data records 412 through 414 shown in FIG. 4A, a man-hour is recorded for each job ID. Alternatively, based on the method shown in FIG. 3B, based on each data record shown in FIG. 1, some records may be generated for each job, and the equivalent information may be extracted from the “job ID” and “man-hour” elements of each record by a data processing function such as a query of DB.

Since the monthly list display of the man-hours per job follows FIG. 5A, a specific illustration is omitted. If “employee ID” at the lower left of the screen 51 shown in FIG. 5A is set as “job ID”, it can be configured as a monthly man-hour management screen of the question.

In this case, FIG. 5B, which is displayed by clicking or the like, for example, on the date column 511 of Tuesday of the week 2, the “employee ID” of the lower left of the screen 52 is set as the “job ID”, and the “employee ID” of the employee who is in charge of the job is displayed at the “attendance/leaving 1”, “ attendance/leaving 2”, and “ attendance/leaving ” 3 of the list. Then, the number of hours that each employee has performed on that day can be configured as a list that is displayed correspondingly. As a result, it is possible to grasp who has participated, how many hours, in the job.

If “employee ID” at the lower left of the screen 53 shown in FIG. 5C is set as “job ID”, it can display the daily total of the man-hour by a bar graph for each day and the sum of those can be plotted as the fold line graph 531.

In this case, the upper limit of the value of the man-hour of the vertical axis may be set as an estimated man-hour that is scheduled in the job. As a result, it is possible to visually grasp how much progress the current state is for the planned estimated man-hour. Further, by plotting the predicted line 534 as a scheduled line for using the estimated man-hour from the start of the work to the delivery date, it is possible to read out the excess and deficiency of the use result of the current man-hour for the schedule.

In FIG. 5D, “employee ID” at the lower left of the screen 54 is set as “job ID”, and each of the employees who are responsible for the job can be displayed as a bar graph on the total of the overtime hours performed in the case, and the sum can be plotted as the fold line graph 541.

In this case, the upper limit of the value of the man-hour of the vertical axis may be set as the predetermined overtime hours planned in the job. As a result, it is possible to visually grasp how much progress the present situation is, for the planned overtime hours. Further, if the predicted line 544 is plotted as a counter line which uses the planned overtime hours from the start of the work to the delivery date, the result of the overtime hours for the plan can be read out.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A server computer connected to an information terminal through a network, wherein the server computer comprises:
at least one memory storing instructions; and
at least one processor configured to execute the instructions to perform operations comprising:
generating, in a database, a first data record recording information including at least a worker ID of a worker, a date and a time of an attendance of the worker,
wherein the generating the first data record is performed in response to the server computer receiving, through the network, information informing of the attendance including the worker ID, and the date and the time of the attendance;
recording the worker ID and the date and the time of the attendance on the generated first data record;
extracting the first data record in response to the server receiving, through the network, information informing of a leaving of the worker,
wherein the extracted first data record comprises a latest attendance time of the worker derived from data records corresponding to the worker in the database;
recording, on the extracted first data record, a time of leaving included in the information informing of the leaving; and
generating another respective data record every time the server computer has received information, through the network, informing of another attendance of the worker.

2. A server computer connected to an information terminal through a network, wherein the server computer comprises:
at least one memory storing instructions; and
at least one processor configured to execute the instructions to perform operations comprising:
generating, in a database, a first data record relating to a worker ID of a worker,
wherein the first data record records information including at least a date and a time of an attendance of the worker, and
wherein the generating the first data record is performed in response to the server computer receiving information, through the network, informing of the attendance including the worker ID of the worker, and the date and the time of the attendance;
recording the worker ID and the date and the time of the attendance on the generated first data record;
extracting the first data record in response to the server receiving, through the network, information informing of a leaving of the worker,
wherein the extracted first data record comprises a latest attendance time of the worker derived from data records corresponding to the worker in the database;
recording, on the extracted first data record, a time of leaving included in the information informing of the leaving; and
generating another respective data record every time the server computer has received information, through the network, informing of another attendance of the worker.

3. An attendance management system comprising:
the server computer according to claim 1.

4. An attendance management system comprising:
the server computer according to claim 2.

5. A server connected to an information terminal through a network, wherein the server comprises:
at least one memory storing instructions; and
at least one processor configured to execute the instructions to perform operations comprising:
generating, in a database, a first data record recording information including at least a date and a time of an attendance of a worker,
wherein the generating the first data record is performed in response to the server receiving information, through the network, informing of the attendance;
recording the date and the time of the attendance on the generated first data record;
extracting the first data record in response to the server receiving, through the network, information informing of a leaving of the worker,
wherein the extracted first data record comprises a latest attendance time of the worker derived from data records corresponding to the worker in the database;
recording, on the extracted first data record, a time of the leaving included in the information informing of the leaving; and
generating another respective data record every time the server computer has received information, through the network, informing of another attendance of the worker.

6. An attendance management system comprising:
the server computer according to claim 5.

7. The server computer according to claim 5, wherein the operations further comprise:
extracting the another respective data record every time the server has received, through the network, information informing of an end of the another respective period of work;
wherein the extracted another respective data record comprises another latest attendance time of the worker derived from data records corresponding to the worker in the database; and
recording, on the extracted another respective data record, a time of the end of the another respective period of work.

8. A non-transitory computer readable storage medium storing instructions which, if executed, cause at least one processor to execute operations comprising:
generating, in a database, a first data record recording information including at least a date and a time of an attendance of a worker,
wherein the generating the first data record is performed in response to the server computer receiving information, through the network, informing of the attendance;
recording the date and the time of the attendance on the generated first data record;
extracting the first data record in response to the server computer receiving, through the network, information informing of a leaving of the worker,
wherein the extracted first data record comprises a latest attendance time of the worker derived from data records corresponding to the worker in the database;
recording, on the extracted first data record, a time of the leaving included in the information informing of the leaving; and
generating another respective data record every time the server computer has received information, through the network, informing of another attendance of the worker.
